(19) United States
(12) Patent Application Publication
(10) Pub. No.: US 2025/0318018 A1
(43) Pub. Date: Oct. 9, 2025

(54) AEROSOL GENERATION DEVICE AND AIR HEATER THEREOF

(71) Applicant: SHENZHEN HUABAO COLLABORATIVE INNOVATION TECHNOLOGY RESEARCH INSTITUTE CO., LTD., Shenzhen (CN)

(72) Inventors: Yuanhao Cui, Shenzhen (CN); Jiaji He, Shenzhen (CN); Siwen Li, Shenzhen (CN); Xiaosong Fu, Shenzhen (CN); Zhiqiang Tang, Shenzhen (CN)

(21) Appl. No.: 19/243,008

(22) Filed: Jun. 19, 2025

Related U.S. Application Data
(63) Continuation of application No. PCT/CN2023/125279, filed on Oct. 18, 2023.

(51) Int. Cl. H05B 3/26; A24F 40/46; A24F 40/485

(52) U.S. Cl. CPC H05B 3/265; A24F 40/46; A24F 40/485

(57) ABSTRACT

The present application provides an aerosol generation device and an air heater thereof. The air heater is capable of being applied to an aerosol generation device for heating an aerosol generation product inserted into the aerosol generation device; the air heater is provided with a cavity, an air inlet hole and an air outlet hole, the cavity is communicated with the outside of the air heater via the air inlet hole and the air outlet hole; a first substrate is further arranged in the cavity of the air heater, and the first substrate is able to change a flow path of air in the cavity. The invention has good heating effect.

### CROSS REFERENCE TO RELATED APPLICATIONS

The present application is a Continuation application of PCT Application No. PCT/CN2023/125279 filed on Oct. 18, 2023, the contents of which are incorporated herein by reference in their entirety.

### TECHNICAL FIELD

The present application relates to the technical field of aerosol generation devices, in particular to an aerosol generation device and an air heater thereof.

### BACKGROUND

Aerosol generation system usually consists of aerosol generation device and aerosol generation product. The aerosol generation product is inserted into the aerosol generation device. The aerosol generation product is heated by the heating device of the aerosol generation device, so as to generate aerosol for users to inhale. The heating element is the key component of the heating device. Generally, it is made of materials with excellent thermal conductivity and stable properties. Air holes are arranged in the substrate to allow air circulation, and heating elements are attached to the substrate. When in use, the heating element converts electric energy into heat energy and transmits it to the substrate, the substrate further heats the air, and the heated air heats the aerosol generation product, thereby generating aerosol.

However, in the prior art, in order to guarantee that the air can be heated rapidly, the heating element's power had to be increased in order to keep the substrate operating continuously at a higher temperature. This led to the substrate's short service life, easy equipment damage, and poor stability.

### SUMMARY OF THE INVENTION

In order to solve the above technical problems, the embodiments of the invention provide an air heater, which can be applied to an aerosol generation device to heat an aerosol generation product inserted into the aerosol generation device; the air heater is provided with a cavity, the air heater is provided with an air inlet hole along the radial direction, and the air heater is provided with an air outlet hole in the axial direction; the cavity is communicated with the outside of the air heater through the air inlet hole and the air outlet hole; and a first substrate is further arranged in the cavity of the air heater, thereby altering a flow path of air in the cavity; and
the air heater further comprises a second substrate in a shape of a hollow tube, a third substrate and a fourth substrate; the air inlet hole is provided on the second substrate, the air outlet hole is provided on the third substrate, the first substrate extends from the fourth substrate, and the third substrate and the fourth substrate are both accommodated in the hollow tube.

As a preferred solution, a direction of an inlet air flow passing through the air inlet hole is different from a direction of outlet air flow passing through the air outlet hole.

As a preferred solution, an airflow volume of the inlet air flow is p1, and an airflow volume of the outlet air flow is p2, and p1≤p2.

As a preferred solution, the first substrate is arranged near the air inlet hole, and the first substrate is able to change the flow path of the inlet air flow.

As a preferred solution, the first substrate blocks or partially blocks the air inlet hole.

As a preferred solution, the cavity is provided between the third substrate and the fourth substrate.

As a preferred solution, in a radial direction of the second substrate, a distance between an inner wall of the first substrate and an inner wall of the second substrate is d1, and a distance between a central axis of the first substrate and a central axis of the second substrate is d2, and d1≤d2.

As a preferred solution, an outer diameter of an orthogonal projection of an area formed by the first substrate distribution in an axial direction is d3, and an outer diameter of an area formed by the air outlet hole distribution is d4, and d3≥d4.

As a preferred solution, the air inlet hole is communicated with the cavity.

As a preferred solution, the air outlet hole is communicated with the cavity, and the third substrate blocks or partially blocks the air outlet hole.

As a preferred solution, the air heater further includes a fifth substrate, and the fifth substrate is detachably connected between the third substrate and the fourth substrate.

As a preferred solution, the air heater further includes a sixth substrate, and the sixth substrate is arranged on the third substrate for supporting the aerosol generation product.

According to the embodiment of the application, when the air heater is applied to an aerosol generation device, air can be heated, thereby heating the aerosol generation product to generate aerosols for users to inhale. Here, the outside air enters the cavity of the air heater via the air inlet hole, and then be exhausted by the air outlet hole, and the air is heated during the air movement. Air can be kept in the cavity for a long time, thus increasing the contact time between air and the air heater, improving the heat exchange efficiency, and further improving the heating effect of air. Furthermore, by providing the first substrate in the cavity of the air heater, it is possible to alter the flow path of air in the cavity and so increase the amount of time that air and the air heater are in contact, enhance heat exchange efficiency, improve air heating effectiveness without raising the heating power of the air heater, achieve sufficient and quick heating, and lessen the impact of prolonged high temperatures on the service life.

In order to solve the above technical problems, the embodiment of the present application further provides an aerosol generation device, which includes a main housing and a fixing assembly, and further includes the above-described air heater installed in the main housing through the fixing assembly.

The aerosol generation device of the embodiment of the present application includes the air heater. When the aerosol generation product is inserted, it can be heated with the air heated by the air heater. The aerosol generating device of the present application can quickly heat the air to the required temperature through the air heater, which allows it to quickly heat the aerosol generation product without using more heating power. The device has excellent stability and a good heating effect.

### BRIEF DESCRIPTION OF THE DRAWINGS

In order to explain the technical solution of the embodiments of this application more clearly, the drawings described in the description of the embodiments of this application will be briefly introduced below. It should be understood that the following drawings illustrate only certain embodiments of the application and therefore should not be considered as limiting the scope. For those of ordinary skill in this field, other drawings may be obtained according to these drawings without any creative effort.

FIG. 1 is a structural schematic diagram of an air heater according to an embodiment of the present application.

FIG. 2 is an exploded-view drawing of an air heater according to an embodiment of the present application.

FIG. 3 is a structural schematic diagram of a longitudinal section of an air heater according to an embodiment of the present application.

FIG. 4 is a structural schematic diagram of a transverse section of an air heater according to an embodiment of the present application.

FIG. 5 is a structural schematic diagram of an air heater according to another embodiment of the present application.

FIG. 6 is a structural schematic diagram of an air heater according to another embodiment of the present application.

FIG. 7 is an exploded-view drawing of an aerosol generation device according to an embodiment of the present application.

FIG. 8 is a cross-sectional schematic diagram of an aerosol generation device according to an embodiment of the present application.

### DETAILED DESCRIPTION OF PREFERRED EMBODIMENTS

Hereinafter, embodiments of the present application will be described in detail, examples of which are illustrated with drawings. The same or similar reference signs indicate the same or similar elements or features having the same or similar functions throughout. The following embodiments, which are explained with reference to the drawings, are merely illustrative and serve to clarify the application; they should not be construed as limiting the application.

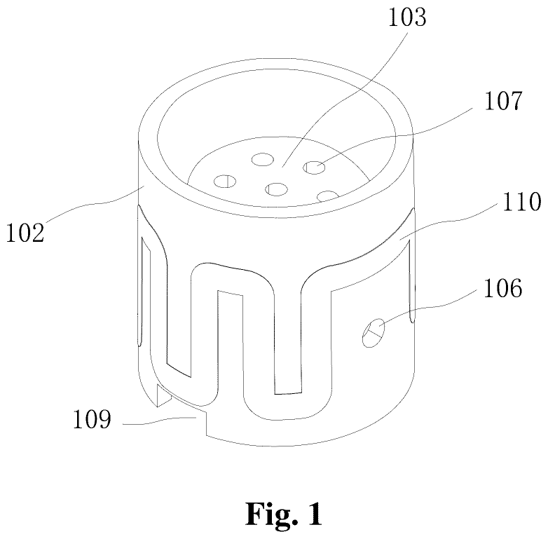

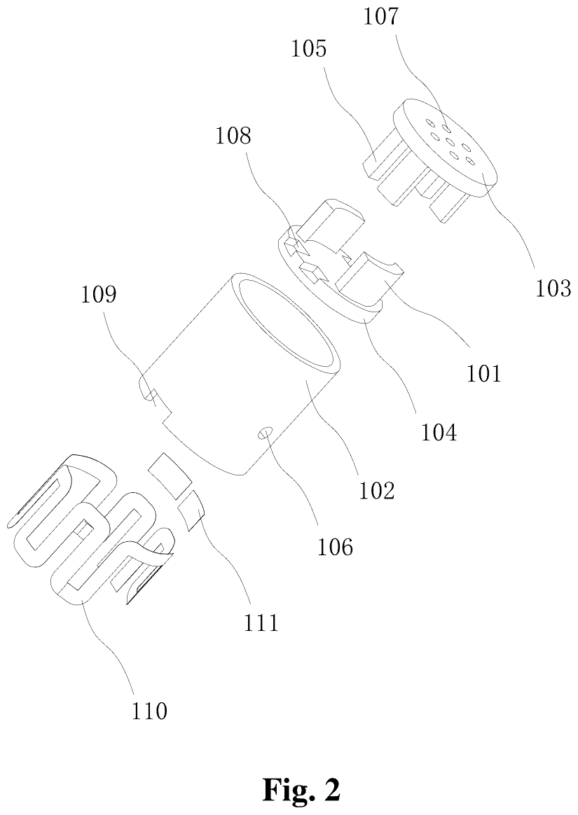

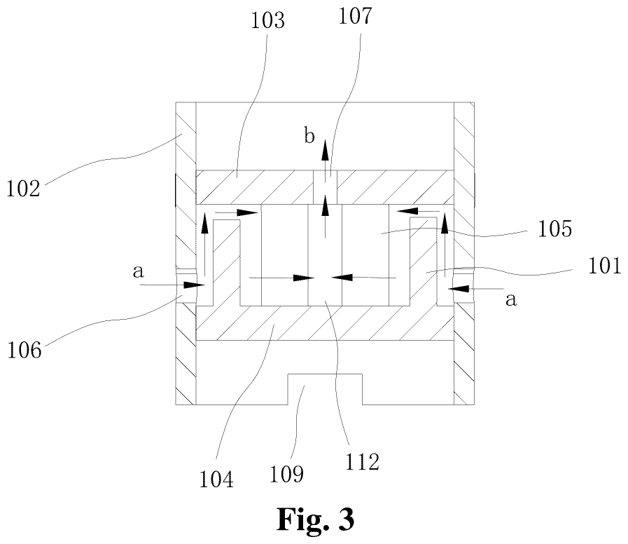

Please refer to FIG. 1, FIG. 2 and FIG. 3, an embodiment of the present application provides an air heater 100, which can be applied to an aerosol generation device for heating an aerosol generation product 200 inserted into the aerosol generation device; the air heater 100 is provided with a cavity 112, an air inlet hole 106 and an air outlet hole 107, the cavity 112 is communicated with the outside of the air heater 100 via the air inlet hole 106 and the air outlet hole 107; a first substrate 101 is further arranged in the cavity 112 of the air heater 100, and the first substrate 101 is able to change a flow path of air in the cavity 112.

According to the embodiment of the application, when the air heater 100 is applied to an aerosol generation device for heating air running through the air heater, thereby heating the aerosol generation product 200 to produce an aerosol to be vaped by users. Specifically, the outside air enters into the cavity 112 of the air heater 100 via the air inlet hole 106, and then be exhausted via the air outlet hole 107, and the air is heated during the air flow movement. The direction of the air outlet hole 107 is the same as an axial direction of a receiving room 410 housing the aerosol generation product 200. The direction of the inlet hole 106 is different than that of the outlet hole 107 so that the air may be retained in the cavity for a longer time, thus increasing the heat exchange time of the air, improving the heat exchange efficiency, and further improving the heating effect of air. Furthermore, by providing the first substrate 101 in the cavity 112 of the air heater 100, it is possible to alter the flow path of air in the cavity 112 and so increase the amount of time that air and the air heater 100 are in contact, enhance heat exchange efficiency, improve air heating effectiveness without raising the heating power of the air heater 100, achieve sufficient and quick heating, and lessen the impact of prolonged high temperatures on the service life.

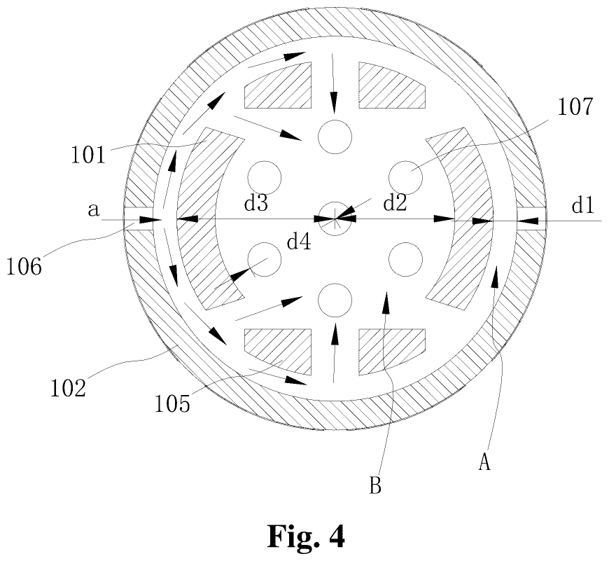

Please refer to FIGS. 3 and 4, the direction of an inlet air flow “a” passing through the air inlet hole 106 is different than that of an outlet air flow “b” passing through the air outlet hole 107.

Understandably, the inlet air flow “a” usually enters from the air inlet hole 106 of the cavity 112, and the outlet air flow “b” is usually exhausted from the air outlet hole 107 of the cavity 112, and the flow directions of the inlet air flow “a” and the outlet air flow “b” are different. Compared with the way that the air flows in and out in the same direction (air passes quickly), the invention allows the air to stay in the cavity for a long time, thus improving the heating effect of the air.

Further, the airflow volume of the inlet air flow “a” is p1, and the airflow volume of the outlet air flow “b” is p2, where p1≤p2.

Understandably, the layout, number and aperture size of the air inlet hole 106 will affect the value of p1, and the layout, number and aperture size of the air outlet hole 107 will affect the value of p2. By adjusting the layouts, numbers and aperture sizes of air inlet hole 106 and air outlet hole 107, the inlet flow and outlet flow can be altered. By adjusting the volume of the inlet air flow, a large amount of cold air can be effectively prevented from entering the cavity 112, and the first substrate 101 can also block the cold air from entering. Together, the two can prevent the cold air from affecting the hot air in the cavity 112, thus avoiding reducing the heating effect of the hot air.

Further, the first substrate 101 is arranged near the air inlet hole 106, and the first substrate 101 is able to change the flow path of the inlet air flow.

Understandably, the paths of air passing through the air heater 100 include an inlet air flow “a”, an outlet air flow “b”, and other flow paths in the cavity 112. The first substrate 101 is close to the air inlet hole 106, i.e., the first substrate 101 can directly block the first air flow coming in from the air inlet hole 106, so that the outside cold air is blocked by the first substrate 101 as soon as it enters the cavity 112. Specifically, the flow direction of the inlet air flow “a” is along the through direction of the air inlet hole 106, and the flow direction of the outlet air flow “b” is along the through direction of the air outlet hole 107. The first substrate 101 changes the direction of the inlet air flow “a”, and the air flow can be disturbed just after entering the air inlet hole 106. When the outside cold air enters the cavity 112 via the air inlet hole 106, the cold air will be blocked by the first substrate 101, so as to avoid the problem that the heating effect will be reduced due to the direct inflow into the outlet air flow “b”. In addition, the first substrate 101 can conduct heat to the newly entered cold air, which has a certain preheating effect. The preheated cold air will flow into the mainstream air flow and finally be discharged as an outlet air flow “b”. The overall air heating effect is better.

Further, the first substrate 101 blocks or partially blocks the air inlet hole 106.

Understandably, in one embodiment, the first substrate 101 completely blocks the air inlet hole 106. That is, after the inlet air flow “a” enters the cavity via the air inlet hole 106, all air will impact the first substrate 106 and the flow path will be changed. In another embodiment, the first substrate 101 partially blocks the air inlet hole 106. That is, after the inlet air flow “a” enters the cavity via the air inlet hole 106, part of the air will impact the first substrate 106 and the flow path will be changed.

Please refer to FIGS. 3 and 4, together with FIGS. 1 and 2, the air heater 100 of an embodiment includes a second substrate 102 in the shape of a hollow tube or a column with a through hole, as well as a third substrate 103 and a fourth substrate 104, both in the shape of plates. The third substrate 103 and the fourth substrate 104 are both arranged in the second substrate 102, and there is a space between the third substrate 103 and the fourth substrate 104 to form the cavity 112. Obviously, the direction of the air outlet hole 107 is the same as the axial direction of the second substrate 102, which in the shape of a hollow tube.

Specifically, in the present embodiments, the second substrate 102 is hollow and tubular, the third substrate 103 is disc-shaped, the fourth substrate 104 is disc-shaped, and the third substrate 103 and the fourth substrate 104 are embedded in the second substrate 102, and a detachable installation manner is adopted, which is convenient for both manufacture and assembly as well as future replacement. The first substrate 101 extends from the fourth substrate 104 along a direction toward the third substrate 103.

In some embodiments, the first substrate 101, the second substrate 102, the third substrate 103 and the fourth substrate 104 are all made of ceramic materials, and the ceramic materials have good heat-resistant and heat-conductive effects. In other embodiments, the second substrate 102, the third substrate 103 and the fourth substrate 104 may be made of other heat-resistant and heat-conductive materials, and the number, shape and size of the second substrate 102, the third substrate 103 and the fourth substrate 104 may be determined according to actual needs.

Further, a heating circuit 110 is arranged on the second substrate 102 according to an embodiment of the present application, and the heating circuit 110 can be electrically connected with a power supply via an electrode 111.

Understandably, the heating circuit 110 can be adopted to generate heat for the present application, including but not limited to being arranged on the second substrate 102 by printing, spraying and the like. In addition, the position of the heating circuit 110 on the second substrate 102 may be either the outer wall of the second substrate 102 or the inner wall of the second substrate 102, and its installation position may be determined according to actual needs, including but not limited to straight line, broken line and S-shape. In some embodiments, the heating circuit 110 is arranged on the outer wall of the second substrate 102, and the heating circuit 110 may be a single-heating circuit. The single-heating circuit has a better heating effect than the double-heating circuit because its maximum temperature point remains in the same position during heating. The installation position of the heating circuit 110 on the second substrate 102 is relatively backward in the axial direction compared with the third substrate 103. That is, compared with the third substrate 103, the heating circuit 110 is farther away from the inserted aerosol generation product 200, thus avoiding the burning of the aerosol generation product 200 caused by the high temperature in the area where the heating circuit 110 is installed in the second substrate 102. In other embodiments, the present application may also use other materials with better heating effect, such as heating wires.

Further, in an embodiment of the present application, in a radial direction of the second substrate 102, a distance between an inner wall of the first substrate 101 and an inner wall of the second substrate 102 is d1, and a distance between a central axis of the first substrate 101 and a central axis of the second substrate 102 is d2, and d1≤d2.

In other embodiments, the first substrate 101 separates the cavity 112 to form an outer space A and an inner space B, and the outer space A is less than or equal to the inner space B.

Understandably, the first substrate 101 is arranged in the cavity 112 of the air heater 100. The first substrate 101 can separate the cavity 112 to form an outer space A and an inner space B. After the air enters through the air inlet hole 106, it first enters the outer space A, and is blocked by the first substrate 101 to change the flow path. Then the air bypasses the first substrate 101 to enter the inner space B from the side. The outer space A can be used for preheating the inlet air flow. The smaller the distance d1 is, the faster the air enters the outer space A and contacts the first substrate 101, so as to be thermally conducted as soon as possible. Distance d1≤distance d2, and the inner space B is larger than the outer space A. This can improve the preheating effect, especially for the cold air, and reduce the influence of the incoming cold air on the heating effect. It should be noted that the outer and outer space here may be divided from a whole space or partial space.

Further, in an embodiment of the present application, an outer diameter of an orthogonal projection of an area formed by the first substrate 101 distribution in an axial direction is d3, and an outer diameter of an area formed by the air outlet hole 107 distribution is d4, and d3≥d4.

Understandably, when d3≥d4, i.e., the size of the area formed by the distribution of the air outlet hole 107 falls within the size range of the area formed by the distribution of the first substrate 101. After the air enters the outer space A, the flow path of the inlet air flow is blocked by the first substrate 101 to change. The inlet air flow cannot be directly discharged from the outer space A via the air outlet hole 107, but needs to continue to change the flow path to bypass the first substrate 101 and enter the inner space, and then be discharged from the air outlet hole 107, so that the heating effect can be improved.

Furthermore, according to an embodiment of the present application, the air inlet hole 106 is provided on the wall of the second substrate 102 and communicated with the cavity 112. In other terms, the first substrate 101 is disposed in an area close to the air inlet hole 106. The air inlet hole 106 is located in the height direction between the third substrate 103 and the fourth substrate 104. In the radial direction of the second substrate 102, the orthographic projection of the air inlet hole 106 overlaps or partially overlaps with the orthographic projection of the first substrate 101, that is, the first substrate 101 blocks or partially blocks the air inlet hole 106. Obviously, the direction of the air inlet hole 106 is not the same as the direction of the air outlet hole 107. In other embodiments, the direction of the air inlet hole 106 and the direction of the air outlet hole 107 are perpendicular to each other.

Specifically, the second substrate 102 is hollow and tubular, the air inlet hole 106 is opened and penetrated along the radial direction of the second substrate 102. Since the air inlet hole 106 is located between the third substrate 103 and the fourth substrate 104, the inlet air flow “a” entered via the air inlet hole 106 can directly enter the cavity 112. When the orthographic projection of the air inlet hole 106 overlaps the orthographic projection of the first substrate 101, all of the inlet air flow “a” will impact and contact the first substrate 101 after entering, and the airflow flow path will be changed by the first substrate 101. When the orthographic projection of the air inlet hole 106 partly overlaps with the orthographic projection of the first substrate 101, a part of the inlet air flow “a” will impact and contact the first substrate 101, and the airflow path will be changed by the first substrate 101, while another part of the inlet air flow “a” will directly enter the inner space B from the outer space A.

Further, according to an embodiment of the present application, the air outlet hole 107 is provided on the third substrate 103. In the axial direction of the second substrate 102, the orthogonal projection of the air outlet hole 107 and the orthogonal projection of the first substrate 101 do not overlap or partially overlap, that is, the first substrate does not block or partially block the hole.

Specifically, the air outlet hole 107 is provided on the third substrate 103 along the axial direction of the second substrate 102. Understandably, the direction of the inlet air flow “a” is perpendicular to the direction of the outlet air flow “b”, so that the air entering the cavity 112 from the air inlet hole 106 will not be directly exhausted from the air outlet hole 107, but will be heated by contacting with the wall of the cavity 112. Compared with the straight-in and straight-out mode, the side air inlet mode improves the heating effect. And the heating effect is further improved by combining the above other structures. The orthographic projection of the air outlet hole 107 and the orthographic projection of the first substrate 101 do not overlap or partially overlap in the axial direction of the second substrate 102. Moreover, d3≥d4 ensures that the inlet air flow cannot be directly exhausted from the outer space A via the air outlet hole 107.

In other embodiments, the air inlet hole 106 is opened on the second substrate 102, and the hole opening direction of the air inlet hole 106 can be adjusted. The air outlet hole 107 is opened on the third substrate 103, and the hole opening direction of the air outlet hole 107 can be adjusted.

Further, in some embodiments, the first substrate 101 and the fourth substrate 104 are integrally formed, which is convenient for manufacture and assembly. In some embodiments, a gap is left between the first substrate 101 and the third substrate 103 to communicate the outer space A and the inner space B. In other embodiments, the first substrate 101 may be integrally formed with the third substrate 103. In other embodiments, the first substrate 101 may be detachably connected with the fourth substrate 104 or the third substrate 103.

Further, according to an embodiment of the present application, the air heater 100 further includes a fifth substrate 105, and the fifth substrate 105 is detachably connected between the third substrate 103 and the fourth substrate 104.

Specifically, in some embodiments, the fifth substrate 105 is made of ceramic material, the fifth substrate 105 is integrally formed with the third substrate 103, and the fourth substrate 104 is provided with a clamping groove into which the fifth substrate 105 can be embedded.

Understandably, when there are a plurality of the first substrates 101 and a plurality of the fifth substrates 105, the first substrate 101 and the fifth substrate 105 are arranged at intervals from each other, so as to leave a gap communicating with the outer space A and the inner space B. Specifically, in some embodiments, there are two first substrates 101 and four fifth substrates 105. And every two fifth substrates 105 are arranged as a group, and each group is arranged at intervals from a single first substrate 101, with a gap between the fifth substrates 105 in each group. There is also a gap between the first substrate and the third substrate, allowing air to pass through the gap between the first substrate and the third substrate, in addition to the gap between the first substrates, the gap between the fifth substrates, and the gap between the first substrate and the fifth substrate. In some embodiments, the first substrate has an arc shape, and the arc shape bulges toward the second substrate.

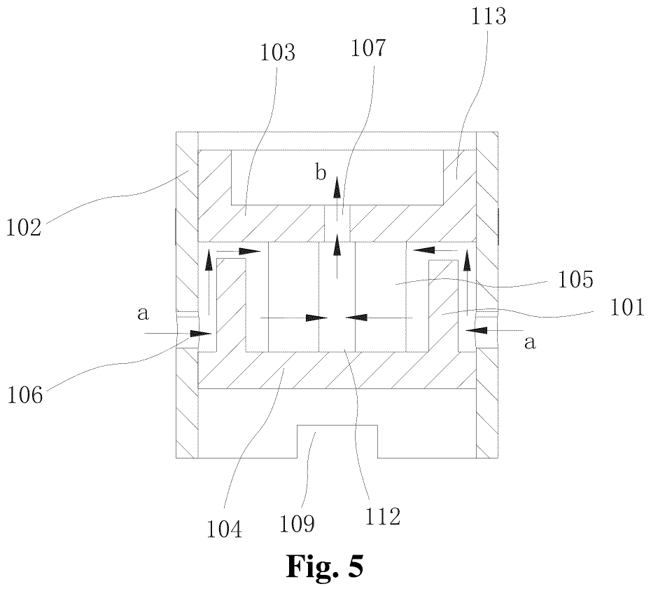

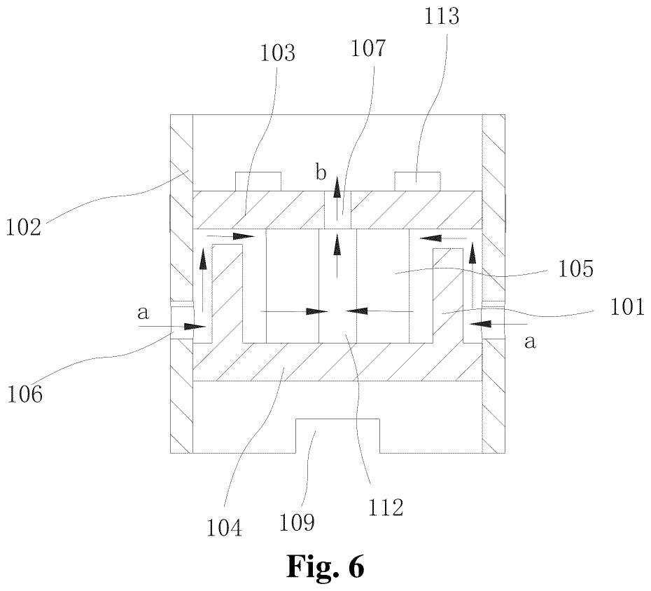

Please refer to FIG. 5 and FIG. 6, together with FIG. 3 and FIG. 4. Further, according to an embodiment of the present application, the air heater 100 includes a sixth substrate 113, and the sixth substrate 113 is arranged on the third substrate 103 for supporting the aerosol generation product 200.

Specifically, the sixth substrate 113 may be made of ceramic material, and the sixth substrate 113 is integrally formed with the third substrate 103. In other embodiments, the sixth substrate 113 is detachably connected with the third substrate 103.

Understandably, in some embodiments, the shape of the sixth substrate 113 is annular. In other embodiments, the shape of the sixth substrate 113 is a block. Understandably, the sixth substrate 113 of the present application may also has other shapes and layouts, and its main function is to support the aerosol generation product 200 and increase the distance between the aerosol generation product 200 and the heating circuit 110, so as to avoid burning caused by overheating.

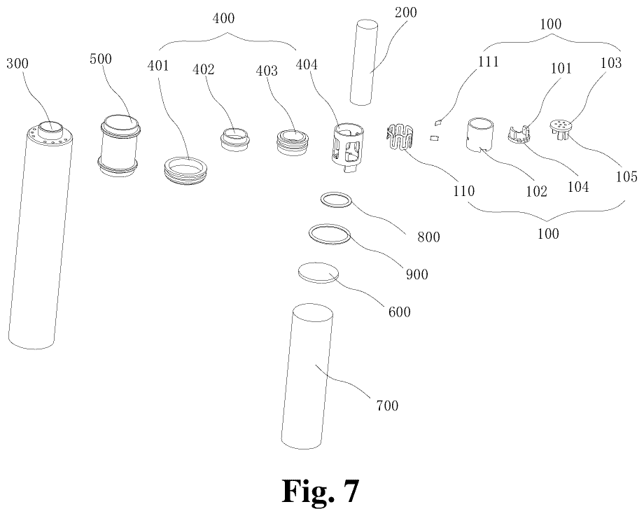

Please refer to FIG. 3 and FIG. 7. It should be noted that the second substrate 102 of the present application is hollow and tubular, and the third substrate 103 and the fourth substrate 104 are provided with a cavity 112. The third substrate 103 and the fourth substrate 104 also separate other spaces of the second substrate 102 to form a accommodating cavity and a preheating cavity. The aerosol generation product 200 can be inserted into the accommodating cavity, and can be heated around all sides by the second substrate 102 while being heated by air.

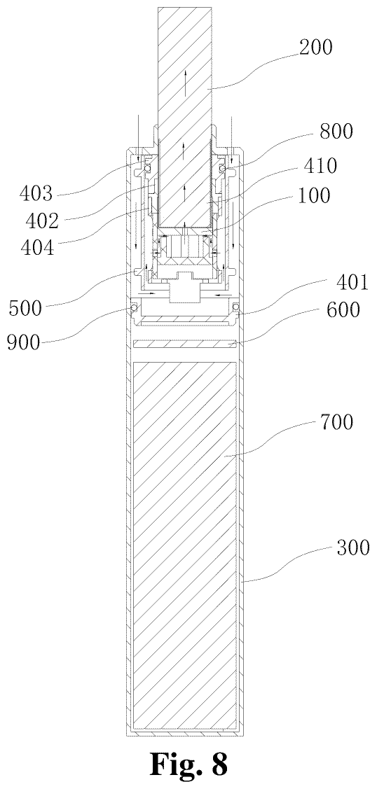

Please refer to FIG. 7 and FIG. 8, together with FIG. 2 and FIG. 3, an embodiment of the present application also provides an aerosol generation device, which includes the air heater 100 as described above.

Further, the aerosol generation device also includes a main housing 300, a fixing assembly 400, a heat insulation pipe 500, a separator plate 600 and a power battery 700. The fixing assembly 400 includes a base 401, a bearing tube 404, a first fixing element 403, a second fixing element 402 and a bearing tube 404.

Specifically, the base 401 is arranged in an inner cavity 112 of the main housing 300, and the bearing tube 404 is arranged on the base 401, the second fixing element 402 is arranged between the first fixing element 403 and the bearing tube 404, and the air heater 100 is arranged between the second fixing element 402 and the bearing tube 404. Here, the first fixing element 403 and the second fixing element 402 can be used to accommodate the aerosol generation product. The second fixing element 403 includes a first insertion part, a second insertion part and a receiving part. The first insertion part is inserted into the bearing tube, and one surface of the receiving part abuts against the bearing tube, while the second insertion part is inserted into the first fixing element, and this end of the first fixing element abuts against the other surface of the receiving part.

Specifically, the main housing 300 is provided with an opening, and an air inlet pore communicated with the inner cavity. The opening is used for inserting the aerosol generation product, and the air inlet port is used for air inlet. The separator plate 600 divides the inner space of the main housing 300 into two parts, the power battery 700 is installed in the lower part, and other structures are arranged in the upper part of the main housing 300. The base 401 is arranged in the main housing 300, and a first rubber sealing ring 900 is arranged between the base 401 and the inner wall of the main housing 300. The bearing tube 404 is installed on the base 401, and the second fixing element 402 is installed between the first fixing element 403 and the bearing tube 404. The second substrate 102 of the air heater 100 is installed between the bearing tube 404 and the second fixing element 402, and a limiting structure is provided to achieve stability.

Specifically, the heat insulation pipe 500 is disposed outside the fixing assembly 400. The heat insulation pipe 500 is sleeved on the periphery of the first fixing element 403, the second fixing element 402 and the bearing tube 404. And a second rubber sealing ring 800 is arranged between the heat insulation pipe 500 and the first fixing element 403.

In some embodiments, the heat insulation pipe 500 has a protrusion, which is arranged on the outer side of the heat insulation pipe 500 in a ring shape. The heat insulation pipe 500 is tightly attached to the inner wall of the main housing 300 via the protrusion, so as to achieve fixation. Here, the inner cavity wall of the main housing 300 may be provided with a groove, so that an air passage can be formed between the heat insulation pipe 500 and the inner cavity wall of the main housing, through which air can pass. Understandably, the heat insulation pipe 500 may also be provided with s groove, and the inner cavity wall of the main housing 300 is provided with a protrusion. In other embodiments, the heat insulation pipe 500 may be directly fastened to the outside of the first fixing element 403 via the second rubber sealing ring 800, and a gap is directly left between the heat insulation pipe 500 and the inner cavity wall of the main housing 300 to form an air passage.

Understandably, outside air can enter the main housing 300 via the air inlet port of the main housing 300, and the air reaches the bottom of the heat insulation pipe 500 along the outside of the heat insulation pipe 500, and then enters the air heater 100 from the hollow area of the bearing tube 404 and the air inlet hole 106 of the second substrate 102 through the inside of the heat insulation pipe 500. Here, air can be preheated between the bottom of the air heater 100 and the base 401. The arrangement of the hollow area of the bearing tube 404 enables the heat of the air heater 100 to be directly conducted, which has a certain preheating effect on the air between the heat insulation pipe 500 and the bearing tube 404, and can also reduce the heat conducted to the bearing tube 404, so as to prevent the user's hand from being overheated due to excessive heat conducted to the main housing 300.

The aerosol generation device of this embodiment includes the air heater as described above. When the aerosol generation product is inserted, it can be heated with the air heated by the air heater. The aerosol generating device of the present application can quickly heat the air to the required temperature through the air heater, which allows it to quickly heat the aerosol generation product without using more heating power. The device has excellent stability and a good heating effect.

The above are merely preferred embodiments of the present application, with more specific and detailed descriptions. They shall not be constructed as limiting the protection scope of the present application. It should be noted that for those skilled in the art, without departing from the concept of the invention, a number of variations and improvements can be made, which shall be included in the scope of protection of the invention.

What is claimed is:

1. An air heater, capable of being applied to an aerosol generation device for heating an aerosol generation product inserted into the aerosol generation device, characterized in that the air heater is provided with a cavity, an air inlet hole and an air outlet hole, the cavity is communicated with the outside of the air heater via the air inlet hole and the air outlet hole; a first substrate is further arranged in the cavity of the air heater, thereby altering a flow path of air in the cavity; and
the air heater further comprises a second substrate in a shape of a hollow tube, a third substrate and a fourth substrate; the air inlet hole is provided on the second substrate, the air outlet hole is provided on the third substrate, and the third substrate and the fourth substrate are both accommodated in the hollow tube.

2. The air heater of claim 1, wherein a direction of inlet air flowing through the air inlet hole is different from a direction of outlet air flowing through the air outlet hole.

3. The air heater of claim 1, wherein an airflow volume of the inlet air is p1, and an airflow volume of the outlet air is p2, and p1≤p2.

4. The air heater of claim 1, wherein the first substrate is arranged near the air inlet hole, and the first substrate is able to change the flow path of the inlet air.

5. The air heater of claim 1, wherein the first substrate blocks or partially blocks the air inlet hole.

6. The air heater of claim 1, wherein the cavity is provided between the third substrate and the fourth substrate.

7. The air heater of claim 6, wherein in a radial direction of the second substrate, a distance between an inner wall of the first substrate and an inner wall of the second substrate is d1, and a distance between a central axis of the first substrate and a central axis of the second substrate is d2, and d1≤d2.

8. The air heater of claim 6, wherein an outer diameter of an orthogonal projection of an area formed by the first substrate distribution in an axial direction is d3, and an outer diameter of an area formed by the air outlet hole distribution is d4, and d3≥d4.

9. The air heater of claim 6, wherein the air inlet hole is communicated with the cavity.

10. The air heater of claim 6, wherein the air outlet hole is communicated with the cavity, and the third substrate blocks or partially blocks the air outlet hole.

11. The air heater of claim 6, wherein the air heater further comprises a fifth substrate, and the fifth substrate is detachably connected between the third substrate and the fourth substrate.

12. The air heater of claim 6, wherein the air heater further comprises a sixth substrate, and the sixth substrate is arranged on the third substrate for supporting the aerosol generation product.

13. An aerosol generation device, comprising the air heater of claim 1.

14. The aerosol generation device of claim 13, wherein the aerosol generation device further comprises a main housing and a fixing assembly; the fixing assembly comprises a base, a bearing tube, a first fixing element and a second fixing element; the base is arranged in an inner cavity of the main housing, and the bearing tube is arranged on the base, the second fixing element is arranged between the first fixing element and the bearing tube, and the air heater is arranged between the second fixing element and the bearing tube.

15. The aerosol generation device of claim 14, wherein the aerosol generation device further comprises a heat insulation pipe, and the heat insulation pipe is arranged outside the fixing assembly.
